(19) United States
(12) Patent Application Publication
(10) Pub. No.: US 2012/0208026 A1
(43) Pub. Date: Aug. 16, 2012

(54) Silica-Coated Magnetic Nanoparticles and Process for Making Same

(75) Inventors: Ke Zhou, Oakville (CA); Paul J. Gerroir, Oakville (CA); Karen A. Moffat, Brantford (CA)

(73) Assignee: XEROX CORPORATION, Norwalk, CT (US)

(21) Appl. No.: 13/024,344

(22) Filed: Feb. 10, 2011

(51) Int. Cl. B32B 5/02; B05D 5/12

(52) U.S. Cl. 428/404; 427/127

(57) ABSTRACT

Disclosed are magnetic coated nanoparticles comprising magnetic cores coated with silica and an organic stabilizer, the magnetic coated nanoparticles having an average particle diameter of no more than about 1,000 nanometers. Also disclosed is a process for preparing silica-coated nanoparticles which comprises: (a) dispersing magnetic nanoparticle cores in a solvent to provide a dispersion having a pH of from about 1 to about 6; (b) adding to the dispersion of magnetic nanoparticles a solution containing tetraethylorthosilicate; and (c) homogenizing or sonicating the dispersion containing the magnetic nanoparticles.

### CROSS-REFERENCE TO RELATED APPLICATIONS

Reference is made to Copending application U.S. Ser. No. 12/886,825, filed Sep. 21, 2010, entitled “Magnetic Toner Compositions,” with the named inventors Ke Zhou, Karen A. Moffat, Richard P. N. Veregin, Paul J. Gerroir, and Cuong Vong, the disclosure of which is totally incorporated herein by reference.

### BACKGROUND

Disclosed herein are magnetic nanoparticles having a silica coating thereover. Also disclosed herein are processes for making these particles.

Finely divided magnetic materials such as iron, cobalt, and the like are known to be pyrophoric. This extreme reactivity has made such nanoparticles difficult to study and inconvenient for practical applications. Iron, cobalt, and other magnetic materials, however have a great deal to offer at the nanoscale, including very potent magnetic properties. Therefore, there is a need to develop magnetic nanoparticles with good stability against oxidation.

While known materials and processes are suitable for their intended purposes, a need remains for improved ferromagnetic and superparamagnetic materials. In addition, a need remains for ferromagnetic and superparamagnetic materials of relatively small particle size. Further, a need remains for nano-scale ferromagnetic and superparamagnetic particles that can be exposed to atmospheric conditions without oxidizing. Additionally, a need remains for nano-scale ferromagnetic and superparamagnetic particles that can be exposed to atmospheric conditions without substantial loss of remanence. There is also a need for methods of making silica-coated ferromagnetic and superparamagnetic nanoparticles that can be carried out simply and at desirably low cost.

### SUMMARY

Disclosed herein are magnetic coated nanoparticles comprising magnetic cores coated with silica and an organic stabilizer, said magnetic coated nanoparticles having an average particle diameter of no more than about 1,000 nanometers. Also disclosed is a process for preparing silica-coated nanoparticles which comprises: (a) dispersing magnetic nanoparticle cores in a solvent to provide a dispersion having a pH of from about 1 to about 6; (b) adding to the dispersion of magnetic nanoparticles a solution containing tetraethylorthosilicate; and (c) homogenizing or sonicating the dispersion containing the magnetic nanoparticles.

### DETAILED DESCRIPTION

The particles disclosed herein comprise magnetic nanoparticles having a silica coating. The coated magnetic nanoparticles can be produced to have different shapes, such as oval, cubic, spherical, hexagonal, or the like, but other shapes are also suitable. Elongated nanoparticles, such as needle or rods-like nanoparticles, are suitable as well. Mixtures of shapes can also be used.

Examples of suitable magnetic nanoparticles include magnetic metallic nanoparticles that include, for example, cobalt and iron, among others. Others include manganese, nickel, barium, and alloys made of all of the foregoing. Additionally, the magnetic nanoparticles can be bimetallic or trimetallic, or a mixture thereof. Examples of suitable bimetallic magnetic nanoparticles include, without limitation, CoPt, fcc (face-centered cubic) phase FePt, fct (face-centered tetragonal) phase FePt, FeCo, MnAl, MnBi, mixtures thereof, and the like. Examples of trimetallic nanoparticles can include, without limitation tri-mixtures of the above magnetic nanoparticles, or core/shell structures that form trimetallic nanoparticles such as Co-covered fct phase FePt.

The magnetic nanoparticles can be prepared by any method known in the art, including ball-milling attrition of larger particles (a common method used in nano-sized pigment production), followed by annealing. The annealing step is generally used because ball milling produces amorphous nanoparticles, which are then subsequently crystallized into the single crystal form. The nanoparticles can also be made directly by RF plasma. Appropriate large-scale RF plasma reactors are available from Tekna Plasma Systems (Sherbrooke, Québec). Metallic Fe nanoparticles can be prepared according to, for example, the methods taught by Watari et al., “Effect of Crystalline Properties on Coercive Force in Iron Acicular Fine Particles,” J. Materials Sci., 23, 1260-1264 (1988); Shah et al., “Effective Magnetic Anisotropy and Coercivity in Fe Nanoparticles Prepared by Inert Gas Condensation,” Int. J. of Modern Phys. B., Vol. 20 (1), 37-47 (2006); and Bonder et al., “Controlling Synthesis of Fe Nanoparticles with Polyethylene Glycol,” J. Magn. Magn. Mater., 311(2), 658-664 (2007), the disclosures of each of which are totally incorporated herein by reference. The fct phase FePt nanoparticle can be synthesized from the fcc phase FePt nanoparticle, according to, for example, the methods taught by Elkins et al., “Monodisperse Face-Centred Tetragonal FePt Nanoparticles with Giant Coercivity,” J. Phys. D: Appl. Phys., pp. 2306-09 (2005); Li et al, “Hard Magnetic FePt Nanoparticles by Salt-Matrix Annealing,” J. Appl. Phy., 99, 08E911 (2006); or Tzitios et al., “Synthesis and Characterization of L1₀ FePt Nanoparticles From Pt (Au, Ag)/γ-Fe₂O₃ Core-Shell Nanoparticles,” Adv. Mater., 17, pp. 2188-92 (2005), the disclosures of each of which are totally incorporated herein by reference.

The nanoparticles can also be made by a number of in situ methods in solvents, including water. For example, metal salts of the desired magnetic core composition can be dissolved in water reduced with a reducing agent, such as a metal hydride, including sodium borohydride or the like, optionally in the presence of a dispersing agent, such as functional polyethers of the formula

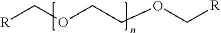

wherein R can be —COOH, —OH, —NH2, —SH, or mixtures thereof, and n is in one embodiment at least about 1, and in another embodiment at least about 5, and in one embodiment no more than about 100, and in another embodiment no more than about 50, such as poly(ethyleneglycol)bis(carboxymethyl)ether (C-PEG), to result in formation of nanosized metal particles. Metal salts can include those of the transition metals, such as iron, cobalt, nickel, manganese, platinum, and the like, as well as other metals such as aluminum, barium, bismuth, and the like, as well as mixtures of two or more of those metals. In one specific embodiment, the mixed metal salts can include salts of iron and cobalt. The metal salts can be, for example, iron (II) chloride tetrahydrate, iron (III) sulfate tetrahydrate, iron (III) phosphate tetrahydrate, iron (III) citrate tetrahydrate, cobalt chloride, iron cobalt salts, or the like, as well as mixtures thereof. In one specific embodiment, the metal salt can be iron (II) chloride tetrahydrate, cobalt chloride, iron cobalt salts, or mixtures thereof. The reaction proceeds, as illustrated for a divalent metal wherein M is the metal, as follows:

MCl₂+NaBH₄+H₂O→M+M(B)+NaCl+H₂+H₂O

For example, when the metal is divalent iron, the reaction proceeds as follows:

FeCl₂+NaBH₄+H₂O→Fe+Fe(B)+NaCl+H₂+H₂O

Also suitable for the magnetic nanoparticle cores are particles prepared as disclosed in U.S. Patent Publication 2009/0325098 and particles prepared as disclosed in Copending Application U.S. Ser. No. 12/886,825, the disclosure of which is totally incorporated herein by reference.

In one specific embodiment, the magnetic nanoparticle cores are an alloy of iron and cobalt. In this embodiment, the iron and cobalt can be present in any desired or effective relative amounts, such as a molar ratio in one embodiment of at least about 10:90 iron:cobalt, in another embodiment at least about 20:80 iron:cobalt, and in yet another embodiment at least about 50:50 iron:cobalt, and in one embodiment no more than about 90:10 iron:cobalt, in another embodiment no more than about 80:20 iron:cobalt, and in yet another embodiment no more than about 70:30 iron:cobalt, and in one embodiment about 60:40 iron:cobalt, although the weight ratio can be outside of these ranges.

The magnetic nanoparticle cores can have any desired or effective shape, such as oval, cubic, spherical, hexagonal, or the like; other shapes are also suitable. Elongated nanoparticles, such as needle or rods-like nanoparticles, are suitable as well. Mixtures of shapes can also be used.

Two types of magnetic nanoparticles can be used for the embodiments disclosed herein. Superparamagnetic nanoparticles have a remanent magnetization equal to zero after being magnetized by a magnet. Ferromagnetic nanoparticles have a remanent magnetization >0, i.e., they maintain a fraction of the magnetization induced by the magnet. Superparamagnetic vs. ferromagnetic property of nanoparticles is generally a function of several factors, including size, shape, material, and temperature. For a given material, at a given temperature, single crystal nanoparticles of a size smaller than a critical size, called critical magnetic domain size (Dc, spherical) are superparamagnetic because of thermal relaxation. Particles above Dc are ferromagnetic. At room temperature, for iron, Dc is about 15 nm while for cobalt, this value is about 7 nm. With alloys the Dc value may change. The actual remanent magnetization of a ferromagnetic nanoparticles material is a function of the single crystal size and of whether the nanoparticle is a single or multidomain nanoparticle. Further information on ferromagnetic property optimization is available in, for example, U.S. Patent Publication 2009/0321676, the disclosure of which is totally incorporated herein by reference.

The magnetic nanoparticle cores are coated with silica (SiO₂). The cores can be coated by any desired or effective method. In one embodiment, nanosized metal core particles can be prepared by reduction of the corresponding metal chloride, followed by redispersing the resulting nanoparticle cores in a solvent and introducing a solution of tetraethyl orthosilicate (TEOS) to the nanoparticle dispersion. Hydrolysis of the TEOS to silica occurs in the solvent under acidic conditions and with homogenization and/or sonication. Subsequent to decanting the solvent while putting a magnet under the container, magnetic nanoparticles coated with silica remain in the container.

More specifically, the magnetic nanoparticle cores are dispersed in any desired or effective solvent, such as methanol, ethanol, water, or the like, as well as mixtures thereof. The magnetic nanoparticles are present in the dispersion in any desired or effective amount, in one embodiment at least about 0.00001 grams per milliliter, and in another embodiment at least about 0.0001 g/ml, and in one embodiment no more than about 10 g/ml, in another embodiment no more than about 1 g/ml, although the amount can be outside of these ranges.

The pH of the magnetic nanoparticle dispersion is in one embodiment maintained at acidic levels, in one embodiment at least about 1, and in another embodiment at least about 2, and in one embodiment no more than about 6, and in another embodiment no more than about 5, although the pH can be outside of these ranges. In some cases, by maintaining the pH too high, TEOS can still hydrolyze, but the iron will not be stable and may form Fe(OH)ₓ. In some cases, by maintaining the pH too low, hydrolysis of TEOS may be so fast that silica may form its own particles without coating onto the surfaces of the magnetic nanoparticle cores.

Thereafter, a solution of TEOS in a solvent, such as methanol, ethanol, or the like as well as mixtures thereof, is prepared. The TEOS is present in the solution in any desired or effective amount, in one embodiment at least about 0.0001 g/ml, in another embodiment at least about 0.001 g/ml, and in yet another embodiment at least about 0.01 g/ml, and in one embodiment no more than about 10 g/ml, in another embodiment no more than about 5 g/ml, and in yet another embodiment no more than about 1 g/ml, although the amount can be outside of these ranges.

The TEOS is added to the magnetic nanoparticles in any desired or effective amount, in one embodiment at least about 0.1 part by weight TEOS per every 100 parts by weight magnetic nanoparticles, and in another embodiment at least about 1 part by weight TEOS per every 100 parts by weight magnetic nanoparticles, and in one embodiment no more than about 1000 parts by weight TEOS per every 100 parts by weight magnetic nanoparticles, although the relative amounts can be outside of these ranges. The relative amount of TEOS with respect to magnetic nanoparticles is believed to be one factor that affects the thickness of the coating of silica formed on the particles.

In one specific embodiment, the TEOS solution is added to the magnetic nanoparticle dispersion with homogenization, in one embodiment at least about 1000 rpm, in another embodiment at least about 2000 rpm, and in yet another embodiment at least about 2500 rpm, and in one embodiment no more than about 35,000 rpm, in another embodiment no more than about 25,000 rpm, and in yet another embodiment no more than about 20,000 rpm, although the stirring speed can be outside of these ranges. Any desired or effective homogenizer can be used, such as an IKA Ultra-turrax T25 batch homogenizer or the like.

In another specific embodiment, the TEOS solution is added to the magnetic nanoparticle dispersion with sonication, in one embodiment at least about 10% amplitude, in another embodiment at least about 25% amplitude, and in yet another embodiment at least about 50% amplitude, and in one embodiment no more than about 100% amplitude, in another embodiment no more than about 90% amplitude, and in yet another embodiment no more than about 80% amplitude, although the value can be outside of these ranges. Any desired or effective sonicator can be used, such as a Branson digital probe sonifier or the like.

In yet another specific embodiment, the TEOS solution is added to the magnetic nanoparticle dispersion with simple stirring.

The TEOS is allowed to hydrolyze in the solvent containing the magnetic nanoparticles for any desired or effective period of time, in one embodiment at least about 1 minute, in another embodiment at least about minutes, and in yet another embodiment at least about 10 minutes, and in one embodiment no more than about 17 hours, in another embodiment no more than about 10 hours, and in yet another embodiment no more than about 5 hours, although the time can be outside of these ranges.

The TEOS is allowed to hydrolyze in the solvent containing the magnetic nanoparticles at any desired or effective temperature, in one embodiment at least about 0° C., in another embodiment at least about 10° C., and in yet another embodiment at least about 20° C., and in one embodiment no more than about 90° C., in another embodiment no more than about 80° C., and in yet another embodiment no more than about 40° C., although the temperature can be outside of these ranges. Higher temperatures will lead to higher and faster hydrolysis rates; in some instances, a hydrolysis rate that is too fast can result in formation of particles containing only silica, without a magnetic core.

Thereafter, the solvent can be removed from the resulting coated particles by any desired or effective method, such as by decanting with a strong magnet under the container followed by air drying.

The silica-coated magnetic nanoparticles can be of any desired or effective average particle diameter, in one embodiment at least about 1 nm, in another embodiment at least about 2 nm, in yet another embodiment at least about 3 nm, in still another embodiment at least about 5 nm, in another embodiment at least about 10 nm, and in yet another embodiment at least about 20 nm, and in one embodiment no more than about 1,000 nm, in another embodiment no more than about 500 nm, in yet another embodiment no more than about 300 nm, in still another embodiment no more than about 250 nm, in another embodiment no more than about 200 nm, and in yet another embodiment no more than about 100 nm, although the average particle diameter can be outside of these ranges. Herein, “average” particle size is represented as d₅₀, or defined as the median particle size value at the 50ₜₕ percentile of the particle size distribution, wherein 50% of the particles in the distribution are greater than the d₅₀ particle size value, and the other 50% of the particles in the distribution are less than the d₅₀ value. Average particle size can be measured by methods that use light scattering technology to infer particle size, such as Dynamic Light Scattering. The particle diameter refers to the length of the particle as derived from images of the particles generated by Transmission Electron Microscopy (TEM) or from Dynamic Light Scattering measurements.

The coercivity of a ferromagnetic material is the intensity of the applied magnetic field required to reduce the magnetization of that material to zero after the magnetization of the sample has been driven to saturation. It measures the resistance of a ferromagnetic material to becoming demagnetized. The coercivity of the silica-coated magnetic nanoparticles can be, for example, in one embodiment at least about 200 Oersteds, in another embodiment at least about 1,000 Oersteds, and in yet another embodiment at least about 10,000 Oersteds, and in one embodiment no more than about 50,000 Oersteds, in another embodiment no more than about 40,000 Oersteds, and in yet another embodiment no more than about 20,000 Oersteds, although the coercivity can be outside of these ranges.

Magnetic saturation is the state reached when an increase in applied external magnetizing field cannot increase the magnetization of the material further, so that the total magnetic field levels off. The saturation magnetization is the maximum induced magnetic moment that can be obtained in a magnetic field; beyond this field no further increase in magnetization occurs. The magnetic saturation of the silica-coated magnetic nanoparticles can be, for example, in one embodiment at least about 10 emu/g, in another embodiment at least about 20 emu/g, and in yet another embodiment at least about 30 emu/g, and in one embodiment no more than about 150 emu/g, in another embodiment no more than about 100 emu/g, and in yet another embodiment no more than about 80 emu/g, although the magnetic saturation can be outside of these ranges.

Remanence, or remanent magnetization, is the magnetization left behind in a permanent magnet after an external magnetic field is removed. It is also the measure of that magnetization. Colloquially, when a magnet is “magnetized,” it has remanence. It is also the magnetic memory in magnetic storage and the source of information on the past Earth's field in paleomagnetism. Sometimes the term retentivity is used for remanence measured in units of magnetic flux density. The remanence of the silica-coated magnetic nanoparticles can be, for example, in one embodiment at least about 10 emu/g, in another embodiment at least about 20 emu/g, and in yet another embodiment at least about 30 emu/g, and in one embodiment no more than about 150 emu/g, in another embodiment no more than about 100 emu/g, and in yet another embodiment no more than about 80 emu/g, although the remanence can be outside of these ranges.

The silica coating on the magnetic nanoparticles can be of any desired or effective thickness, in one embodiment at least about 0.1 nanometers, in another embodiment at least about 0.5 nm, and in yet another embodiment at least about 1 nm, and in one embodiment no more than about 100 nm, in another embodiment no more than about 50 nm, in yet another embodiment no more than about 20 nm, and in still another embodiment no more than about 10 nm, although the thickness can be outside of these ranges.

Specific embodiments will now be described in detail. These examples are intended to be illustrative, and the claims are not limited to the materials, conditions, or process parameters set forth in these embodiments. All parts and percentages are by weight unless otherwise indicated.

### Comparative Example A

In a 600 mL glass beaker was dissolved 5.73 g FeCl₂.4H₂O, obtained from Sigma-Aldrich, and 2.06 g CoCl₂, obtained from Sigma-Aldrich, in 250 mL of deionized water. In another 600 mL glass reactor was dissolved 2.4 g NaBH₄, obtained from Sigma-Aldrich, in 250 mL of deionized water. In a third 4,000 mL glass beaker was mixed 6.6 mL poly(ethyleneglycol)bis(carboxymethyl)ether (C-PEG, obtained from Sigma-Aldrich) and 250 mL deionized water. Thereafter, the iron chloride/cobalt chloride solution was poured into the 4,000 ml beaker containing C-PEG under stirring using a magnetic bar, followed by pouring the sodium borohydride solution into the mixture under stirring using a magnetic bar. Stirring continued for 30 minutes. The resulting dispersion was then settled using magnets; the mother liquor was decanted and was transferred to a plastic dish and dried in a fume hood overnight.

### Example I

The process of Comparative Example A was repeated, except that after decanting the mother liquor, which had a pH of 3.3, the nanoparticles were washed once with deionized water. The solution of Fe/Co nanoparticles in deionized water had a pH of 4.4.

After decanting, the particle wet cake was re-dispersed in 50 g of methanol in a 600 mL beaker. In another 200 mL beaker was added 4.78 g of tetraethyl orthosilicate (TEOS, obtained from Sigma-Aldrich). The TEOS/methanol solution was added to the Fe/Co nanoparticle dispersion slowly under homogenization at rpm 6,500 using an IKA Ultra-turrax T25 batch homogenizer. The mixture was kept homogenized for about 2 h, after which it was transferred to a plastic dish and dried in a fume hood overnight.

### Example II

The process of Example I was repeated, except that the TEOS/methanol solution was added to the Fe/Co nano-particle dispersion under sonication instead of homogenization using a Branson digital probe sonifier. The mixture was kept sonicated for about 1 h, after which it was transferred to a plastic dish and dried in a fume hood overnight.

### Results

The iron/cobalt nanoparticles generated in Comparative Example A became rusty overnight, indicating that oxidation had occurred. In contrast, the iron/cobalt nanoparticles generated in Examples I and II remained black, indicating the presence of little or no oxidation, even after a period of months. A transmission electron microscope (TEM) image of the particles generated in Example I indicated that the Fe/Co nanoparticles formed long chains because of the magnetic attraction of each particle lining up in a chain formation. The particles were not aggregated together, but magnetically attracted to each other. The Fe/Co nanoparticles appeared to be encapsulated in a thin membrane or sheath-like material, believed to be silica. The magnetic properties of the particles (using commercially available magnetite from Magnox Pulaski Incorporated for comparison purposes) were measured using a Digital Fluxmeter System, consisting of two modules, a fixed field permeameter having a fixed field magnet of 4000 Oersteds and an integrating digital fluxmeter display, and a remanence box. The magnetic properties were as follows:

| | Magnetization | |
|---|---|---|
| | saturation (based on | |
| | total material) | Remanence |
| Magnox Pulaski magnetite | 66 emu/g | 5.30 emu/g |
| Comparative Example A | 30.84 emu/g | 22.43 emu/g |
| Example I | 41.49 emu/g | 30.85 emu/g |
| Example II | 72.92 emu/g | 20.8 emu/g |

Comparative Example A's particles were measured after exposure to atmosphere overnight and oxidation. As the results indicate, the magnetic properties of the silica-coated nanoparticles generated in Examples I and II were superior to those of Magnox Pulaski magnetite and the nanoparticles generated in Comparative Example A.

### Example III

About 2 g of FeCl₂.4H₂O are dissolved in about 100 mL of water in a 250 mL glass beaker. About 4 g of NaBH₄ are dissolved in about 100 mL of water in a separate 250 mL glass beaker. About 2 mL of poly(ethyleneglycol)bis(carboxymethyl)ether (C-PEG) is added to a 1000 mL glass beaker. The iron chloride solution is then poured into the 1000 mL beaker containing the C-PEG with stirring using a magnetic bar, followed by the addition of the NaBH₄ solution with stirring using the magnetic bar. Stirring occurs at a rate of about 200 rpm and continues for about 30 minutes. The resulting dispersion is then settled using magnets; the mother liquor is removed and the resulting material is then washed three times with deionized water. The obtained Fe nanoparticles possess a circularity of about 1.

The iron nanoparticles thus obtained are then re-dispersed in methanol and the process of Example I is repeated using these iron nanoparticles instead of the Fe/Co nanoparticles. It is believed that similar results will be obtained.

### Example IV

Iron nanoparticles are prepared by the process described in Example III. The iron nanoparticles thus obtained are then re-dispersed in methanol and the process of Example II is repeated using these iron nanoparticles instead of the Fe/Co nanoparticles. It is believed that similar results will be obtained.

### Example V

About 0.964 g of FeCl₂.4H₂O and about 0.412 g CoCl₂ are dissolved in about 50 mL of water in a 125 mL glass beaker. About 0.240 g of NaBH₄ is dissolved in about 50 mL of water in a separate 125 mL glass beaker. About 1 mL C-PEG and about 50 mL deionized water are mixed in a 400 mL glass beaker. The iron chloride/cobalt chloride solution is then poured into the 400 mL beaker containing C-PEG under stirring using a magnetic bar, followed by the addition of the NaBH₄ solution with stirring using the magnetic bar. Stirring continues at a rate of about 200 rpm for about 30 minutes. The resulting dispersion is then settled using magnets; the mother liquor is removed and the resulting material is then washed three times with deionized water. The resulting Fe/Co alloy nanoparticles possess a circularity of about 1.

The iron/cobalt nanoparticles thus obtained are then re-dispersed in methanol and the process of Example I is repeated using these iron nanoparticles instead of the Fe/Co nanoparticles Example II. It is believed that similar results will be obtained.

### Example VI

Iron/cobalt nanoparticles are prepared by the process described in Example V. The iron/cobalt nanoparticles thus obtained are then re-dispersed in methanol and the process of Example II is repeated using these iron/cobalt nanoparticles instead of the Fe/Co nanoparticles of Example II. It is believed that similar results will be obtained.

### Example VII

The processes of Examples I and II are repeated, except that instead of the Fe/Co particles generated in situ, uncoated iron nanoparticles (50 nm average particle diameter) obtained from MTI Corp. (Richmond, Calif.) are used. It is believed that similar results will be observed.

### Example VIII

The processes of Examples I and II are repeated, except that the ratio of FeCl₂ to CoCl₂ used is a molar ratio of 30:70. It is believed that similar results will be observed.

### Example IX

The processes of Examples I and II are repeated, except that the ratio of FeCl₂ to CoCl₂ used is a molar ratio of 40:60. It is believed that similar results will be observed.

### Example X

The processes of Examples I and II are repeated, except that the ratio of FeCl₂ to CoCl₂ used is a molar ratio of 80:20. It is believed that similar results will be observed.

### Example XI

The processes of Examples I and II are repeated, except that the ratio of FeCl₂ to CoCl₂ is a molar ratio of 70:30. It is believed that similar results will be observed.

### Example XII

The processes of Examples I and II are repeated, except that instead of a mixture of FeCl₂.4H₂O and CoCl₂, a mixture of FeCl₂.4H₂O and NiCl₂, available from Sigma-Aldrich, in the same molar ratio are used to generate magnetic nanoparticle cores of iron/nickel. It is believed that similar results will be obtained.

### Example XIII

The processes of Examples I and II are repeated, except that instead of a mixture of FeCl₂.4H₂O and CoCl₂, MnCl₂, available from Sigma-Aldrich, in an equimolar amount to the total amount of iron and nickel in Examples I and II, is used to generate magnetic manganese nanoparticle cores. It is believed that similar results will be obtained.

### Example XIV

The processes of Examples I and II are repeated, except that instead of a mixture of FeCl₂.4H₂O and CoCl₂, FePt particles in an equimolar amount are used to generate magnetic nanoparticle cores. FePt particles are prepared as disclosed in Li, et al., J. Applied Physics 99, 08E911 (2006), and in U.S. Patent Publication 2009/0325098, “Magnetic Pigment Example B”, the disclosures of each of which are totally incorporated herein by reference. It is believed that similar results will be obtained.

Other embodiments and modifications of the present invention may occur to those of ordinary skill in the art subsequent to a review of the information presented herein; these embodiments and modifications, as well as equivalents thereof, are also included within the scope of this invention.

The recited order of processing elements or sequences, or the use of numbers, letters, or other designations therefor, is not intended to limit a claimed process to any order except as specified in the claim itself.

What is claimed is:

1. Magnetic coated nanoparticles comprising magnetic cores coated with silica and an organic stabilizer, said magnetic coated nanoparticles having an average particle diameter of no more than about 1,000 nanometers.

2. Magnetic coated nanoparticles according to claim 1 wherein the cores comprise an alloy of iron and cobalt.

3. Magnetic coated nanoparticles according to claim 1 wherein the organic stabilizer is a functional polyether of the formula 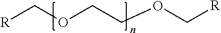
wherein R is —COOH, —OH, —NH2, —SH, or mixtures thereof, and n is from 1 to about 100.

4. Magnetic coated nanoparticles according to claim 1 wherein the organic stabilizer is poly(ethyleneglycol)bis(carboxymethyl)ether.

5. Magnetic coated nanoparticles according to claim 1 wherein the particles have an average particle diameter of from about 2 to about 500 nm.

6. Magnetic coated nanoparticles according to claim 1 wherein the particles have a coercivity of from about 200 to about 50,000 Oersteds.

7. Magnetic coated nanoparticles according to claim 1 wherein the particles have a magnetic saturation of from about 20 to about 150 emu/g.

8. Magnetic coated nanoparticles according to claim 1 wherein the particles have a remanence of from about 10 to about 150 emu/g.

9. Magnetic coated nanoparticles according to claim 1 wherein the silica coating has a thickness of from about 0.1 to about 100 nm.

10. Magnetic coated nanoparticles according to claim 1 wherein the particles are ferromagnetic.

11. Magnetic coated nanoparticles according to claim 1 wherein the particles are superparamagnetic.

12. Magnetic coated nanoparticles comprising magnetic cores coated with silica and a functional polyether organic stabilizer of the formula 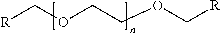
wherein R is —COOH, —OH, —NH2, —SH, or mixtures thereof, and n is from 1 to about 100, said magnetic coated nanoparticles having an average particle diameter of no more than about 1,000 nanometers, wherein the silica coating has a thickness of from about 0.1 to about 100 nm.

13. A process for preparing silica-coated nanoparticles which comprises:
(a) dispersing magnetic nanoparticle cores in a solvent to provide a dispersion having a pH of from about 1 to about 6;
(b) adding to the dispersion of magnetic nanoparticles a solution containing tetraethylorthosilicate; and
(c) homogenizing or sonicating the dispersion containing the magnetic nanoparticles.

14. A process according to claim 13 wherein the magnetic nanoparticle cores comprise (a) iron, (b) cobalt, (c) manganese, (d) nickel, (e) barium, (f) an alloy of iron, cobalt, manganese, nickel, barium, or a mixture thereof, (g) CoPt, (h) fcc FePt, (i) fct FePt, (j) FeCo, (k) MnAl, (l) MnBi, or (m) a mixture of one or more of (a) through (l).

15. A process according to claim 13 wherein the magnetic nanoparticle cores comprise an alloy of iron and cobalt.

16. A process according to claim 13 wherein the homogenization or sonication is conducted for from about 1 minute to about 17 hours at a temperature of from about 0° C. to about 90° C.

17. A process according to claim 13 wherein the magnetic nanoparticle cores are prepared by a process which comprises:
(1) providing a first aqueous solution comprising at least one metal salt and a functional polyether stabilizer;
(2) providing a second solution comprising a metal hydride reducing agent; and
(3) combining the first and second solutions to produce magnetic nanoparticle cores.

18. A process according to claim 13 wherein the tetraethylorthosilicate is added to the magnetic nanoparticle cores with homogenization at from about 1,000 to about 35,000 rpm.

19. A process according to claim 13 wherein the dispersion of magnetic nanoparticle cores having a pH of from about 1 to about 6 further contains a functional polyether of the formula 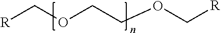
wherein R is —COOH, —OH, —NH2, —SH, or mixtures thereof, and n is from 1 to about 100.

20. A process according to claim 13 wherein the functional polyether is poly(ethyleneglycol)bis(carboxymethyl)ether.
